(19) United States
(12) Patent Application Publication
(10) Pub. No.: US 2008/0142494 A1
(43) Pub. Date: Jun. 19, 2008

(54) THERMALLY REGULATED HEATER FOR MOTOR VEHICLES

(76) Inventors: Barre Blake, Birmingham, MI (US); Thomas M. Goral, Oakland Twp., MI (US); Eric Kowal, Macomb, MI (US); Frans Mercx, Bergen op Zoom (NL); Arthur Vermolen, La Nucia (Alicante) (ES)

Correspondence Address: SABIC - 08CT;SABIC Innovative Plastics - IP Legal, ONE PLASTICS AVENUE, PITTSFIELD, MA, 01201-3697, US

(21) Appl. No.: 11/612,508

(22) Filed: Dec. 19, 2006

(51) Int. Cl. H05B 11/00; H05B 3/10

(52) U.S. Cl. 219/217; 29/611

(57) ABSTRACT

A thermally regulating heater and a heated seat made using these heaters wherein the resulting heated seat provides enhanced temperature control without the need of any temperature control system. The heaters include the use of a polymeric positive temperature coefficient composition that operates at lower trip temperatures than previous polymeric positive temperature coefficient compositions. The polymeric positive temperature coefficient composition have a trip temperature below the heat deflection temperature of the composition such that the polymeric positive temperature coefficient composition heats the heated seat to a temperature closer to the comfort level of an individual using the heated seat. Since the polymeric positive temperature coefficient composition uses plastic materials, the polymeric positive temperature coefficient composition can be formed into different shapes as needed using a molding process, such as injection molding.

### FIELD OF INVENTION

The present invention relates to thermally regulated heaters and, in particular, to thermally regulated heaters and heated seats using these heaters for use in motor vehicles.

### BACKGROUND OF INVENTION

Heating devices with temperature self-regulating characteristics are extensively used in the automotive industry. Oftentimes, these heating devices are used in interior applications. For example, electrically heated seats are used in vehicles for reasons of comfort and safety. One such embodiment of heated seats is one wherein the heating device is located in the seat itself. In this embodiment, both the driver's seat and the other seats in the vehicle can be arranged so that they can be heated by means of special heating elements in the shape of electrically conducting wires, which are arranged in the shape of a heating coil in the seats. Such a heating coil is normally placed in the cushion and in the backrest of the seats on production. In addition, the heating element is connected to a current feeding unit that delivers current. In this way, the heating element can be heated to a suitable temperature.

A problem with these heating elements arises from the need to have a carefully adjusted temperature on the surface of each seat, i.e. on the surface that a person traveling in the vehicle will feel. To this end, the temperature of the heating element is controlled by means of a temperature sensor that is arranged in close connection to the heating element and that is connected to a central control unit. By means of the temperature sensor and the control unit, the ambient temperature can be detected. The control unit can also include current feeding circuits for feeding current to the heating element. As such, the central heating element is arranged to feed a certain current through the heating element until a certain desired value of the temperature is obtained. The setting of this selected value can, for example, be carried out by means of fixed resistances or by means of an adjustable potentiometer that is controlled by those traveling in the vehicle.

By means of the above-described control method, current can be delivered to the heating element until the central control unit indicates that the selected value has been reached. When this is the case, the current feed is interrupted. This causes the heating element to successively be cooled. When the heating element has cooled so much that its temperature again falls below the desired value, the current feeding to the heating element will be resumed. In this manner, the temperature control will continue as long as the system is active.

Although these systems normally provide a reliable heating and temperature control for a vehicle seat, they do, however, have several negatives. These negatives result from the fact that previous systems including a temperature sensor are generally arranged such that the temperature sensor is in close connection to or on the heating element itself, which results in a relatively quick heating of the sensor. This often results in the temperature control being started before the surface temperature of the seat has reached the selected value. In addition, relatively quick temperature shifts of the sensor can occur during the temperature control. As a whole, this results in the seat being heated relatively slowly, i.e. the seat is given a temperature that slowly approaches the preset value. In order to compensate, a higher preset value for the temperature sensor in the seat is used. Unfortunately, when the control is active during a longer period, the temperature in the seat approaches this higher temperature, which often results in a too high temperature in the seat when it is used for a longer period of time.

In attempts to compensate for these problems, in certain prior art embodiments, the temperature sensor has been placed at a distance from the heating element. In this embodiment, temperature control of the seat ends up being started after the surface temperature of the seat has reached the preselected value. This causes a temperature control of lower quality or no temperature control at all, and also, depending on the types of materials used, can result in too high a temperature in the seat. Accordingly, this embodiment results in too rapid a heating with too large a temperature variation. Placing the temperature sensor far from the heating element also reduces the possibility of discovering any possible short circuits in the heating element that can result in, for example, too high a temperature on the surface of the seat.

In addition, these prior art embodiments suffer from several other problems. Many of these heating elements are known to build up static electricity, which damages the heater controller circuit when it is discharged. Another problem is that the current prior art seat heater designs create several problems in that heating is localized to the area of the wires, creating an unfavorable heating pattern where the areas in the vicinity of the wire are too hot and areas removed from the wire are too cool. Moreover, since the heating wire itself does not possess any means for regulating the temperature, a sophisticated temperature controller is required for regulating the temperature of the seat heater. This creates a challenging design problem for the engineer.

In alternative prior art heating elements for heated seats, a coated metal coil is used, primarily tin-plated or silver-coated copper conductors. Despite this coating, and as a result of environmental conditions, these heat conductors often suffer from corrosion, which is induced by moisture and the influence of salts. Due to this formation of corrosion, the heat conductors experience damaging reductions in cross-sectional areas, followed by localized overheating and finally to a breakage of the heat conductor, which results in a shortened service life of the heat conductor. Furthermore, the metal coating, such as silver or tin, increases the friction between the individual filaments of the heat conductor to such an extent that due to its increased rigidity, the heat conductor can become bent or broken, and thus can be severely damaged. A further drawback of a metallic coating of the individual heat conductor filaments is the greatly differing redox potential of the coating metals relative to the actual material of the wire. In those instances wherein the coating is not free of pores and/or gaps or defect areas are present, corrosion can occur under the influence of electrolytes formed of water and salt, and hence a dissolving or decomposition of the base metal, which in turn represents damage to the heat conductor. Finally, the mechanical requirements of such conductors in seats are very high, which in many cases cannot be satisfactorily realized.

In addition, with prior art solutions, the use of metal coils and wires results in a material that is stiff, yet upon which a passenger sits, thereby making prior art solutions uncomfortable.

Accordingly, it would be beneficial to provide a heated seat for use in motor vehicles that provides more consistent heating of the seat while reducing the risk of damaging the seat due to excess amounts of electrical power and/or too high an operating temperature. It would also be beneficial to provide a heated seat for use in motor vehicles that is eliminates the need for a temperature control system and/or temperature sensors to artificially lower the temperature at which the material stops heating. It would also be beneficial to provide a heated seat for use in motor vehicles that has more uniform heating of the seat. It would also be beneficial to provide a heated seat for use in motor vehicles that is flexible, durable, and able to withstand the demands of the operating environment. It would also be beneficial to provide a heated seat for use in motor vehicles that could be designed to have a smaller or larger surface area to permit the heating element to be used in different designs. It would also be beneficial to provide a heated seat for use in motor vehicles that can be constructed from a plastic material capable of being formed using a molding process.

### SUMMARY OF THE INVENTION

The present invention provides thermally regulated heated seats. These seats may be used in motor vehicles to heat individuals sitting in the seat without the problems associated with prior art heated seat solutions. The heated seats include heating elements that include a self-regulating, thermally regulating material that has a lower natural trip temperature than prior art PTC materials. As such, the heated seats of the present invention do not require the use of temperature control elements that were previously used in conventional heated seats to shut off the heating element before the heated seat became uncomfortable to the individual. The thermally regulating articles utilize a positive temperature coefficient (PTC) material that operates at a selected trip temperature that is lower than conventional PTC materials and that may be selected based upon the intended use of the material. As such, the trip temperature of the PTC material is chosen to enable the article to be heated to selected design temperature that does not exceed the comfort level of the person in the seat. In addition, the use of the PTC material enables more uniform heating than some prior art heated seats.

In one aspect, the present invention provides a heated seat including a molded polymeric positive temperature coefficient composition and at least two electrodes in electrical contact with the heated seat for supplying electric current to the heated seat, wherein the molded polymeric positive temperature coefficient composition comprises an organic polymer and a conductive filler.

In another aspect, the present invention provides a method of forming a heated seat including the steps of forming a molded heated seat comprising a polymeric positive temperature coefficient composition and integrating at least two electrodes in electrical contact with the heated seat for supplying electric current to the heated seat.

### BRIEF DESCRIPTION OF THE DRAWINGS

FIG. 1 is a perspective view of a heated seat according to one embodiment of the present invention.

FIG. 2 is a perspective view of a heated seat according to another embodiment of the present invention.

FIGS. 3A-3B are perspective views of a prior art heated seat (FIG. 3A) and of a heated seat according to yet another embodiment of a heated seat (FIG. 3B) according to the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a thermally regulating heater and a heated seat made using these heaters. The heaters include the use of a thermally regulating material that stops heating at a lower trip temperature than prior art positive temperature coefficient materials, thereby eliminating the need for the temperature control elements to ensure that the heated seat does not become too hot to the individual. The trip temperature of the positive temperature coefficient materials used in the present invention is selected to be sufficiently low to enable the article to be heated to a temperature below standard polymeric positive temperature coefficient materials without the risk of the article reaching an unsafe temperature while still permitting efficient and/or substantially uniform heating of the article.

Accordingly, one aspect of the present invention provides a thermally regulating heater that includes a positive temperature coefficient material. Positive temperature coefficient (PTC) materials are materials that exhibit variable electrical resistance with temperature. As the temperature of the material increases, the electrical resistance also increases. The resistivity of the material increases so current flow is reduced, limiting heat flow. The PTC materials used in the present invention are designed to have a lower trip temperature as compared to prior art materials. As used herein, the “trip temperature” is the temperature that results in a substantial increase in the resistivity of the material. Prior to the trip temperature, the resistivity of the polymeric material does not change very much with a change in temperature. After the trip temperature, however, there is an increase of several orders of magnitude in the resistivity with temperature.

By utilizing a PTC material designed to have a lower trip temperature, the resulting thermally regulating heater will trip at lower temperatures than prior art polymeric PTC materials. In general, prior art polymeric PTC materials trip at a temperature close to the heat deflection temperature (HDT) of the plastic material. Since the HDT for most plastic materials is 120° C. or higher, this results in a shutoff temperature for the PTC material well in excess of what would be considered to be comfortable to an individual sitting in the heated seat. As discussed, some prior art heated seats therefore required the use of temperature sensors and/or controllers to artificially lower the trip temperature of the heated seat.

However, the heated seats of the present invention use a polymeric PTC material that has a trip temperature less than the heat deflection temperature (HDT) of the base polymer. As a result, these PTC materials trip at much lower temperatures that are closer to the comfort level of an individual. Therefore, while temperature sensors and/or temperature controllers may still be used, their use is not required. Accordingly, the thermally regulating heaters and heated seats of the present invention are less complex, easier to use and/or permit greater control in designing applications utilizing these thermally regulating heaters than prior art PTC materials.

In addition, the thermally regulating heaters of the present invention, since they are constructed using a plastic base material, can be designed such that the polymeric PTC material is located throughout the entirety of the heated seat or, in alternative embodiments, only in portions of the heated seat. In those embodiments wherein the polymeric PTC material is located throughout all or substantially all of the heated seat, substantially uniform heating of the heated seat can be achieved as compared to prior art heaters wherein localized heating often occurs.

As discussed, the thermally regulating heaters of the present invention can achieve substantially uniform heating through the use of a thermoplastic thermally regulating heater. In this embodiment, a polymeric PTC material is used to form the thermally regulating heater. The polymeric PTC material includes an organic polymer and an electrically conducting filler composition that includes ceramic fillers and/or metal powders. The use of a polymeric PTC material enables the thermally regulating heater to be formed into different shapes depending on the selected use of the thermally regulating heater in the heated seat.

In one embodiment, the polymeric PTC material is formed into a selected shape, such as a coil. In an alternative embodiment, the polymeric PTC material is formed in a random shape or in no shape but still formed in a manner to enable the PTC material to exhibit PTC characteristics at a selected temperature. In yet another embodiment, the thermally regulating heater is in a form of an electro-thermally active polymeric film or foam that has current applied to the material, which heats up to a specified temperature. In still another embodiment, the thermally regulating heater extruded as a film or injection molded into a fan or blower housing.

In an alternative embodiment, the thermally regulating heater is selected to be flexible since the comfort of a vehicle seat is based, in part, on the materials used as well as the flexibility of the seat. Accordingly, the thermally regulating heater is, in one embodiment, selected such that the heater conforms to the design of the seat and/or compliments the other flexible components of the seat. In general, the thermally regulating heater may be formed into any selected shape depending on one or more factors including, but not limited to, the type of heated seat, the shape of the heated seat, the type of polymeric PTC material used, the selected location of the thermally regulating heater in the heated seat, the use of a temperature control system or lack thereof, or a combination including one or more of the foregoing factors.

Accordingly, in one aspect, the present invention provides a heated seat that uses a polymeric PTC material that has a lower trip temperature than prior art polymeric PTC materials. Using a PTC material tuned to a lower trip temperature cut-off, there is no need to monitor the temperature externally to ensure that the heated seat does not become too hot for the individual, although temperature controllers can be provided as an added feature. In addition, since polymeric PTC materials are used, the PTC material, in one embodiment, can also be formed into three dimensional shapes or flat sheets to meet different application requirements.

The polymeric PTC material used in the thermally regulating heater is a PTC material that includes any PTC material capable of having a trip temperature less than the heat deflection temperature (HDT) of the composition at 0.45 MPa and wherein the difference between the trip temperature and the heat deflection temperature is, in one embodiment, 10° C. or greater. In another embodiment, the PTC material has a trip temperature less than the HDT of the composition at 0.45 MPa and wherein the difference between the trip temperature and the HDT is 20° C. or greater. In still another embodiment, the PTC material has a trip temperature less than the HDT of the composition at 0.45 MPa and wherein the difference between the trip temperature and the HDT is 30° C. or greater.

As a result, the thermally regulating heaters of the present invention shut off at lower temperatures that are closer to the comfort temperature of the individual. Based on, the trip temperature of the PTC material, the location of the thermally regulating heater in the seat and/or the use of any insulation, the thermally regulating heaters of the present invention can be designed to heat a seat without exceeding the comfort temperature of an individual while also doing so without the need for any temperature control system. As used herein, a “comfort temperature” is a temperature above which an individual would feel discomfort. Since the heated seat will contact an individual, the trip temperature for the PTC material is beneficially selected such that the comfort temperature chosen enables the heated seat to be heated, but not be hot to the touch. In one embodiment, the comfort temperature is 50° C. or less. In another embodiment, the comfort temperature is 40° C. or less. In still another embodiment, the comfort temperature is 30° C. or less. Depending on one or more factors, such as the shape of heated seat, the location of the PTC material in the article, and/or the use of any insulation, a comfort temperature of 50° C. or less may be achieved using, in one embodiment, a PTC material having a selected trip temperature of 100° C. or less. In another embodiment, the PTC material has a selected trip temperature of 80° C. or less. In still another embodiment, the PTC material has a selected trip temperature of 60° C. or less.

The PTC material used in the thermally regulating heater can, in alternative embodiments, also include any PTC material capable of having a preselected trip temperature designed into the PTC material. As such, the self-regulating PTC materials used in the present invention are selected from those wherein the trip temperature is designed into the material and the PTC material will trip at or near the trip temperature substantially all of the time, thereby making the PTC material self-regulating at a given temperature.

The organic polymer used in the polymeric PTC compositions may be selected from a wide variety of thermoplastic resins, thermosetting resins, blends of thermoplastic resins, blends of thermosetting resins, or blends of thermoplastic resins with thermosetting resins. The organic polymer can include a blend of polymers, copolymers, terpolymers, ionomers, or combinations including at least one of the organic polymers.

The organic polymers can include semi-crystalline polymers or amorphous polymers. Examples of the organic polymers that can be used are polyolefins such as polyethylene, polypropylene; polyamides such as Nylon 4,6, Nylon 6, Nylon 6,6, Nylon 6, 10, Nylon 6, 12; polyesters such as polyethelene terephthalate (PET), polybutylene terephthalate (PBT), poly(1,4-cyclohexane-dimethanol-1,4-cyclohexanedicarboxylate) (PCCD), poly(trimethylene terephthalate) (PTT), poly(cyclohexanedimethanol-co-ethylene terephthalate) (PETG), poly(ethylene naphthalate) (PEN), poly(butylene naphthalate) (PBN); polyarylates, polyimides, polyacetals, polyacrylics, polycarbonates (PC), polystyrenes, polyamideimides, polyacrylates, polymethacrylates such as polymethylacrylate, or polymethylmethacrylate (PMMA); polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polysiloxanes, polyolefins, or the like, or a combination including at least one of the foregoing organic polymers. Exemplary organic polymers are polycarbonates, polyolefins, polyamides, polyetherimides, polystyrenes or polyacrylates.

Examples of blends of organic polymers that can be used in the amorphous form include acrylonitrile-butadiene-styrene/nylon, polycarbonate/acrylonitrile-butadiene-styrene, polyphenylene ether/polystyrene, polyphenylene ether/polyamide, polycarbonate/polyester blends, such as, for example PC-PCCD, PC-PETG, PC-PET, PC-PBT, PC-PCT, PC-PPC, PC-PCCD-PETG, PC-PCCD-PCT, PC-polyarylates, polycarbonate/polyetherimide, polyphenylene ether/polyolefin, or the like, or a combination including at least one of the foregoing blends of organic polymers.

Examples of copolymers that may be used in the polymeric PTC composition are ethylene vinyl acetate, ethylene vinyl alcohol, ethylene ethyl acrylate, ethylene methyl acrylate, ethylene butyl acrylate, copolyestercarbonates, polyetherimide-polysiloxanes, or the like, or a combination including at least one of the foregoing polymers.

In one embodiment, the organic polymers can be thermosetting organic polymers. Examples of thermosetting organic polymers are epoxies, phenolics, polyurethanes, polysiloxanes, or the like, or a combination including at least one of the foregoing thermosetting organic polymers.

The organic polymers are generally used in amounts of 5 to 70 weight percent (wt %) of the total weight of the polymeric PTC composition. In one embodiment, the organic polymers are generally used in amounts of 10 to 65 wt % of the total weight of the polymeric PTC composition. In another embodiment, the organic polymers are generally used in amounts of 15 to 60 wt % of the total weight of the polymeric PTC composition. In yet another embodiment, the organic polymers are generally used in amounts of 20 to 55 wt % of the total weight of the polymeric PTC composition.

As noted above, the polymeric PTC composition includes, in one embodiment, a ceramic filler and a metal powder. It is beneficial for the ceramic filler and the metal powder to be electrically conducting. In one embodiment, it is generally beneficial for the ceramic filler and the metal powder to have a hardness of greater than or equal to 500 Vickers. The ceramic fillers may exist in the form of spheres, flakes, fibers, whiskers, or the like, or a combination including at least one of the foregoing forms. These ceramic fillers may have cross-sectional geometries that may be circular, ellipsoidal, triangular, rectangular, polygonal, or a combination including at least one of the foregoing geometries. The ceramic fillers, as commercially available, may exist in the form of aggregates or agglomerates prior to incorporation into the insulating layer or even after incorporation into the insulating layer. An aggregate includes more than one filler particle in physical contact with one another, while an agglomerate includes more than one aggregate in physical contact with one another. An exemplary particle geometry for the ceramic fillers and the metal powders is spherical.

In one embodiment, it is beneficial for the ceramic fillers to be electrically conducting. It is generally beneficial for the ceramic fillers to have an electrical resistivity of 1 to 1×10⁷ microohm-cm. In one embodiment, the ceramic fillers have an electrical resistivity of 5 to 50 microohm-cm. In another embodiment, the ceramic fillers have an electrical resistivity of 15 to 30 microohm-cm.

It is also beneficial for the at least one of the conducting fillers (ceramic or metal) fillers to have a hardness of greater than or equal to 500 Vickers. In another embodiment, it is beneficial for the ceramic filler to have a hardness of greater than or equal to 550 Vickers. In yet another embodiment, it is beneficial for the ceramic filler to have a hardness of greater than or equal to 600 Vickers. In yet another embodiment, it is beneficial for the ceramic filler to have a hardness of greater than or equal to 700 Vickers. In yet another embodiment, it is beneficial for the ceramic filler to have a hardness of greater than or equal to 900 Vickers.

Examples of suitable ceramic fillers are metal oxides, metal carbides, metal nitrides, metal hydroxides, metal oxides having hydroxide coatings, metal carbonitrides, metal oxynitrides, metal borides, metal borocarbides, or the like, or a combination including at least one of the foregoing inorganic materials. Metal cations in the foregoing ceramic fillers can be transition metals, alkali metals, alkaline earth metals, rare earth metals, or the like, or a combination including at least one of the foregoing metal cations.

Examples of suitable electrically conducting ceramic fillers are titanium diborides (TiB₂) tungsten carbide (WC), tin oxide, indium tin oxide (ITO), antimony tin oxide, titanium nitride (TiN), zirconium nitride (ZrN), titanium carbide (TiC), molybdenum silicide (MoSi₂), potassium titanate whiskers, vanadium oxides (V₂O₃), or a combination including at least one of the foregoing ceramic fillers.

Examples of suitable metal powders include silver, vanadium, tungsten, nickel, or the like, or a combination including at least one of the foregoing metals. Metal alloys can also be added to the polymeric PTC composition. Examples of metal alloys include stainless steel, neodymium iron boron (NdFeB), samarium cobalt (SmCo), aluminum nickel cobalt (AlNiCo), or the like, or a combination including at least one of the foregoing.

The ceramic fillers and/or the metal powders can be nanoparticles or micrometer sized particles. Nanoparticles are those that have at least one dimension in the nanometer range (e.g., 10⁻⁹ meters). Particles having at least one dimension that is less than or equal to 1,000 nanometers (nm) are considered nanoparticles, while particles having at least one dimension of greater than 1,000 nanometers are considered micrometer sized particles.

When the ceramic fillers and/or the metal powders are nanoparticles it is beneficial to have an average particle size of less than or equal to 500 nm. In one embodiment, it is beneficial for the average particle size to be less than or equal to 200 nm. In another embodiment, it is beneficial for the average particle size to be less than or equal to 100 nm. In yet another embodiment, it is beneficial for the average particle size to be less than or equal to 50 nm.

If the ceramic fillers and/or the metal powders are micrometer-sized particles then it is beneficial to have an average particle size of greater than or equal to 1.1 micrometers (μm). In one embodiment, it is beneficial for the average particle size to be greater than or equal to 1.2 μm. In another embodiment, it is beneficial for the average particle size to be greater than or equal to 1.5 μm. In yet another embodiment, it is beneficial for the average particle size to be greater than or equal to 2.0 μm. In another embodiment, it is beneficial for the particle sizes to be greater than or equal to 100 μm.

The electrically conducting fillers, that include the ceramic fillers and the metal powders, are used in an amount of 30 to 95 wt %, based on the total weight of the polymeric PTC composition. In one embodiment, the electrically conducting fillers are used in an amount of 40 to 90 wt %, based on the total weight of the polymeric PTC composition. In yet another embodiment, the electrically conducting fillers are used in an amount of 45 to 85 wt %, based on the total weight of the polymeric PTC composition. In an exemplary embodiment, the electrically conducting fillers are used in an amount of 70 to 95 wt %, based on the total weight of the polymeric PTC composition.

The ceramic fillers are generally present in an amount of 10 to 100 wt % of the total weight of the electrically conductive fillers. In one embodiment, the ceramic fillers are present in an amount of 20 to 85 wt % of the total weight of the electrically conductive fillers. In another embodiment, the ceramic fillers are present in an amount of 30 to 75 wt % of the total weight of the electrically conductive fillers. In yet another embodiment, the ceramic fillers are present in an amount of 40 to 65 wt % of the total weight of the electrically conductive fillers.

Metal powders are used in amount of up to 90 wt % of the total weight of the electrically conductive fillers. In one embodiment, the metal powders are used in amount of up to 15 to 80 wt % of the total weight of the electrically conductive fillers. In another embodiment, the metal powders are used in amount of up to 25 to 70 wt % of the total weight of the electrically conductive fillers. In yet another embodiment, the ceramic fillers are present in an amount of 35 to 60 wt % of the total weight of the electrically conductive fillers.

In alternative embodiments, the polymeric PTC compositions may include alternative conductive fibers, either in addition to or in lieu of the ceramic fillers and/or metal powders provided the resulting polymeric PTC composition has a trip temperature below the HDT of the polymeric PTC composition. These alternative electrically conducting fillers can include, in select embodiments, carbonaceous fillers such as for example carbon black, metal coated fillers, carbon nanotubes, graphite, or the like, or a combination including at least one of the foregoing carbonaceous fillers.

Carbon black having average particle sizes of less than or equal to 200 nm are beneficial. In one embodiment, the carbon black has an average particle sizes of less than or equal to 100 nm can be used. In another embodiment, the carbon black has an average particle sizes of less than or equal to 50 nm can be used. Exemplary carbon blacks are those that have surface areas greater than 200 square meter per gram (m²/g). Exemplary carbon blacks include the carbon black commercially available from Columbian Chemicals under the trade name CONDUCTEX®; the acetylene black available from Chevron Chemical, under the trade names S.C.F. (Super Conductive Furnace) and E.C.F.® (Electric Conductive Furnace); the carbon blacks available from Cabot Corp. under the trade names VULCAN XC72® and BLACK PEARLS®; and the carbon blacks commercially available from Akzo Co. Ltd under the trade names KETJEN BLACK EC 300® and EC 600® respectively.

Non-conductive, non-metallic fillers that have been coated over a substantial portion of their surface with a coherent layer of solid conductive metal may also be used in alternative embodiments of the polymeric PTC composition. The non-conductive, non-metallic fillers are commonly referred to as substrates, and substrates coated with a layer of solid conductive metal may be referred to as “metal coated fillers”. Exemplary conductive metals such as aluminum, copper, magnesium, chromium, tin, nickel, silver, iron, titanium, or the like, or a combination including at least one of the foregoing metals may be used to coat the substrates. Examples of substrates are well known in the art and include those described in “Plastic Additives Handbook, 5th Edition” Hans Zweifel, Ed, Carl Hanser Verlag Publishers, Munich, 2001. Examples of such substrates include silica powder, such as fused silica and crystalline silica, boron-nitride powder, boron-silicate powders, alumina, magnesium oxide (or magnesia), wollastonite, including surface treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, mica, feldspar, silicate spheres, flue dust, cenospheres, fillite, aluminosilicate (armospheres), natural silica sand, quartz, quartzite, perlite, tripoli, diatomaceous earth, synthetic silica, or the like, or a combination including at least one of the foregoing substrates. All of the aforementioned substrates may be coated with a layer of metallic material for use in the polymeric PTC composition.

Carbon nanotubes can include single wall carbon nanotubes, multiwall carbon nanotubes, or the like. The carbon nanotubes generally have aspect ratios of greater than or equal to 2. In one embodiment, the carbon nanotubes have aspect ratios of greater than or equal to 100. In another embodiment, the carbon nanotubes have aspect ratios of greater than or equal to 1,000. The carbon nanotubes have diameters of 2 nm to 500 nm. In one embodiment, the carbon nanotubes have diameters of 5 nm to 100 nm. In one embodiment, the carbon nanotubes have diameters of 10 nm to 70 nm.

Graphite fibers are generally obtained from the pyrolysis of pitch or polyacrylonitrile (PAN) based fibers. Graphite fibers having diameters of 1 micrometer to 30 micrometers and lengths of 0.5 millimeter to 2 centimeters can be used in the polymeric PTC composition.

Regardless of the exact size, shape and composition of the alternative electrically conducting fillers, they may be dispersed into the organic polymer in amounts of up to 20 wt % of the total weight of the polymeric PTC composition. In one embodiment, the alternative electrically conducting fillers may be dispersed into the organic polymer in amounts of 0.01 to 15 wt % of the total weight of the polymeric PTC composition. In another embodiment, the alternative electrically conducting fillers may be dispersed into the organic polymer in amounts of 0.1 to 12 wt % of the total weight of the polymeric PTC composition. In yet another embodiment, the electrically conducting fillers may be dispersed into the organic polymer in amounts of 1 to 10 wt % of the total weight of the polymeric PTC composition.

In another embodiment, electrically non-conducting, fibrous, reinforcing fillers may be added to the polymeric PTC composition. When present, the electrically non-conducting, fibrous, reinforcing fillers are selected from those that will impart improved properties to the polymeric PTC compositions, and that have an aspect ratio greater than 1. As used herein, “fibrous” fillers may therefore exist in the form of whiskers, needles, rods, tubes, strands, elongated platelets, lamellar platelets, ellipsoids, micro fibers, nanofibers and nanotubes, elongated fullerenes, or the like. Where such fillers exist in aggregate form, an aggregate having an aspect ratio greater than 1 will also suffice for the purpose of this invention. Examples of such fillers well known in the art include those described in “Plastic Additives Handbook, 5^{th} Edition” Hans Zweifel, Ed, Carl Hanser Verlag Publishers, Munich, 2001. Non-limiting examples of suitable fibrous fillers include short inorganic fibers, including processed mineral fibers such as those derived from blends including at least one of aluminum silicates, aluminum oxides, magnesium oxides, and calcium sulfate hemihydrate, boron fibers, ceramic fibers such as silicon carbide, and fibers from mixed oxides of aluminum, boron and silicon sold under the trade name NEXTEL® by 3M Co., St. Paul, Minn., USA. Also included among fibrous fillers are single crystal fibers or “whiskers” including silicon carbide, alumina, boron carbide, iron, nickel, copper. Fibrous fillers such as glass fibers, basalt fibers, including textile glass fibers and quartz may also be included.

Also included are natural organic fibers including wood flour obtained by pulverizing wood, and fibrous products such as cellulose, cotton, sisal, jute, cloth, hemp cloth, felt, and natural cellulosic fabrics such as Kraft paper, cotton paper and glass fiber containing paper, starch, cork flour, lignin, ground nut shells, corn, rice grain husks and mixtures including at least one of the foregoing.

Synthetic reinforcing fibers may also be used. This includes organic polymers capable of forming fibers such as polyethylene terephthalate, polybutylene terephthalate and other polyesters, polyarylates, polyethylene, polyvinylalcohol, polytetrafluoroethylene, acrylic resins, high tenacity fibers with high thermal stability including aromatic polyamides, polyaramid fibers such as those commercially available from Du Pont de Nemours under the trade name KEVLAR®, polybenzimidazole, polyimide fibers such as those available from Dow Chemical Co. under the trade names polyimide 2080 and PBZ fiber, polyphenylene sulfide, polyether ether ketone, polyimide, polybenzoxazole, aromatic polyimides or polyetherimides, and the like. Combinations of any of the foregoing synthetic reinforcing fibers may also be used.

When the polymeric PTC composition is used to form at least a part of the heated seat, the polymeric PTC composition includes at least two electrodes placed in electrical contact with the heated seat such that electrical current is capable of being applied to the polymeric PTC composition in the heated seat. The electrodes may be placed on an exterior surface of the heated seat or may be molded into the heated seat using any known method for integrating electrodes with a heated seat. The electrodes may include an electrode path for distributing electric current throughout the polymeric PTC composition in the heated seat. The electrode path is integrated with the electrodes and the heated seat to enable uniform or substantially uniform electric current to be distributed throughout the heated seat.

The electrodes may be in the form of wires, plates, rods, or the like. The electrodes may be constructed of metal including, but not limited to, copper, silver, lead, or zinc. In alternative embodiment, the electrodes may also be made of a nonmetal substance, such as carbon. The electrodes may include connections for a wire harness, such as blades or tips. The electrodes may include an electrode path that is simply a portion of the electrodes themselves. In an alternative embodiment, the electrode path may be a separate material capable of carrying electric current from the electrodes to the heated seat. Accordingly, the electrode path may include wires or rods distributed along or within the heated seat in electrical contact with the polymeric PTC composition in the heated seat. Conversely, in an alternative embodiment, the electrode path may include a conductive ink, such as a silver ink, that is distributed along the heated seat in electrical contact with the polymeric PTC composition and the electrodes.

In use, current is applied to the electrodes that then distribute the current to the polymeric PTC composition, either alone or in conjunction with the electrode path. The heated seat is designed such that electric current is supplied in a uniform or substantially uniform manner to the polymeric PTC composition. The polymeric PTC composition then heats up to a specified temperature. As described, the polymeric PTC composition trips at a selected temperature to result in a heated seat that is self-regulating and that operates at trip temperatures closer to comfort temperatures thereby reducing the chance of discomfort to an individual due to excessive heating.

In an alternative embodiment of the present invention, the thermally regulating heater includes a support sheet that supports the polymeric PTC composition. In one embodiment, the support sheet is constructed from a material that is capable of being formed from one piece. Examples of such materials include, but are not limited to, plastics, such as thermoplastics and thermosets. In select embodiments of the present invention, the support sheet for the thermally regulating heater is constructed from a plastic material, such as a thermoplastic material. Examples of thermoplastic polymers that may be used in the present invention include, but are not limited to, polyethylene (PE), including high-density polyethylene (HDPE), linear low-density polyethylene LLDPE, low-density polyethylene (LDPE), mid-density polyethylene (MDPE), maleic anhydride functionalized polyethylene, maleic anhydride functionalized elastomeric ethylene copolymers, ethylene-butene copolymers, ethylene-octenene copolymers, ethylene-acrylate copolymers like ethylene-methyl acrylate, ethyelene-ethyl acrylate and ethtylene butyl acrylate copolymers, glycidyl methacrylate modified polyethylene, polypropylene (PP), maleic anhydride functionalized polypropylene, glycidyl methacrylate modified polypropylene, polyvinyl chloride (PVC), polyvinyl acetate, polyvinyl acetyl, acrylic resin, syndiotactic polystyrene (sPS), polyamides, including but not limited to PA6, PA66, PA11, PA12, PA6T, PA9T, poly-tetra-fluorethylene (PTFE), polybutylene-terephthalate (PBT), polyphenylene-sulfide (PPS), polyamideimide, polyimide, Polyethylene vinyl acetate (EVA), glycidyl methacrylate modified polyethylene vinyl acetate, Polyvinylalcohol, poly(methyl methacrylate) (PMMA), polyisobutylene, poly(vinylidene chloride), poly(vinylidene fluoride) (PVDF), poly(methylacrylate), polyacrylonitrile, polybutadiene, polyethylene-terephthalate (PET), poly(8-aminocaprylic acid), poly(vinyl alcohol) (PVA), polycaprolactone, or blends, mixtures or combinations of one or more of these polymers.

The polymeric PTC compositions and/or the thermally regulating heater may be formed using any method capable of forming a plastic article. Examples of such methods include, but are not limited to, injection molding, compression molding, injection-compression molding, blow molding, a die casting process or a combination thereof. In one embodiment, the polymeric PTC compositions and/or the thermally regulating heater may be formed using an injection molding process.

The foregoing and other features of the present invention will be more readily apparent from the following detailed description and drawings of the illustrative embodiments of the invention wherein like reference numbers refer to similar elements.

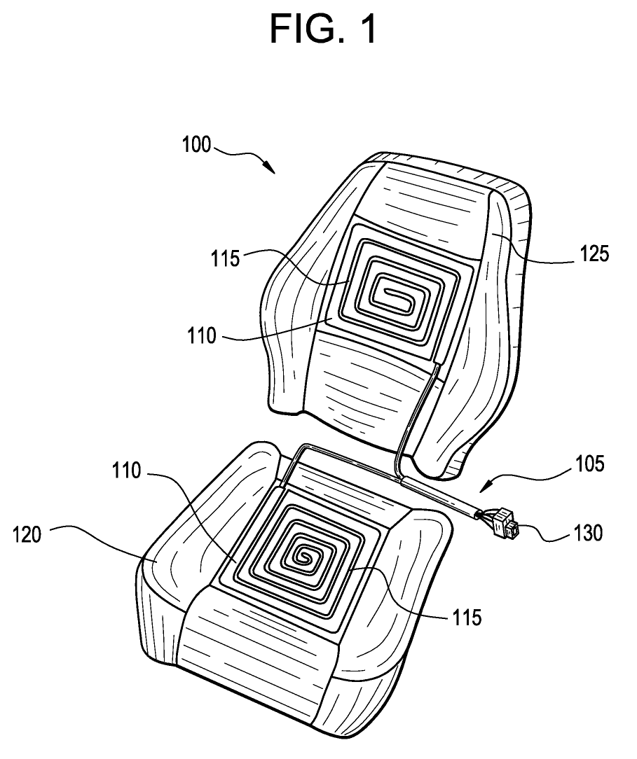

FIG. 1 provides one embodiment of a thermally regulating heater and an article made that includes the heater. In this embodiment, the article is a heated seat 100. The heated seat 100 includes a thermally regulating heater 105 that includes a polymeric PTC composition 110 and an electrode 115 on the polymeric PTC composition 110. In this embodiment, the polymeric PTC composition 110 is in a form of a film or other flexible substrate. These thermally regulating heater 105 is located within the heated seat 100. In this embodiment, the thermally regulating heater 105 includes two localized portions in the seat area 120 of the heated seat 100 and in the back area 125 of the heated seat 100. While the thermally regulating heater 105 shows portions in the seat area 120 and the back area 125, it is to be understood that the thermally regulating heater 105 may include only the seat area 120 or the back area 125. In this embodiment, the electrodes 115 may be selected from conductive inks, such as silver ink, or wires or rods placed in electrical contact with the polymeric PTC composition 110.

As previously discussed, the polymeric PTC composition 110 is constructed from a polymeric PTC composition that operates at a lower trip temperature and is designed to shut of at a preselected temperature closer to the comfort temperature of an individual in the heated seat 100. As such, as can be seen, no temperature sensor or temperature control system is needed to ensure that the temperature of the heated seat 100 does not become too hot. Rather, the heated seat 100 includes a single connection 130 that enables the thermally regulating heater 105 to be turned on and off. The seat area 120 and the back area 125 of the thermally regulating heater 105 can, in this embodiment, be insert molded or adhesively attached to the respective locations of the heated seat 100.

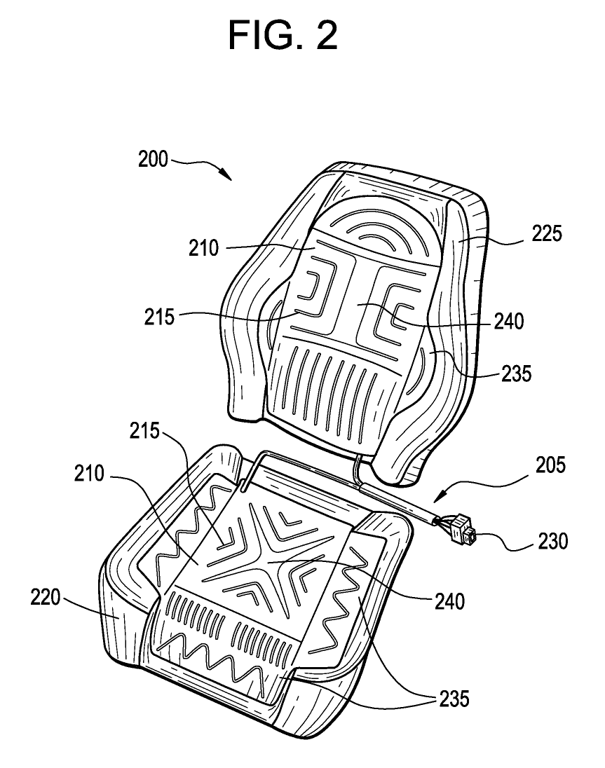

FIG. 2 provides an alternative embodiment to FIG. 1 that shows a similar structure. In this embodiment, the article is also a heated seat 200. The heated seat 200 includes a thermally regulating heater 205 that includes a polymeric PTC composition 210 and an electrode 215 located on the polymeric PTC composition 210. In this embodiment, the thermally regulating heater 205 includes two larger coil electrodes 215. The thermally regulating heater 205 includes two sections with one of the sections in the seat area 220 of the heated seat 200 and another section in the back area 225 of the heated seat 200. As compared to the thermally regulating heater in FIG. 1, the thermally regulating heater 205 in FIG. 2 includes greater surface area through the use of wing sections 235 to provide more uniform heating throughout the heated seat 200. The thermally regulating heater 205 may also include one or more openings 240 in the substrate to permit greater flexibility of the thermally regulating heater 205. Also, as with FIG. 1, while the thermally regulating heater 205 shows portions in the seat area 220 and the back area 225, it is to be understood that the thermally regulating heater 205 may include only the seat area 220 or the back area 225 heater. In this embodiment, the polymeric PTC composition 210 is in a form of a film or other flexible substrate. Also, in this embodiment, the electrodes 215 may be selected from conductive inks, such as silver ink, or wires or rods placed in electrical contact with the polymeric PTC composition 210.

As with the embodiment described in FIG. 1 discussed, the polymeric PTC composition 210 is constructed from a PTC material that operates at a lower trip temperature and is designed to shut of at a preselected temperature. Therefore, the heated seat 200 includes only a single connection 230 that enables the thermally regulating heater 205 to be turned on and off. As with the embodiment depicted in FIG. 1, the seat area 220 and the back area 225 of the thermally regulating heater 205 can, in this embodiment, be insert molded or adhesively attached to the respective locations of the heated seat 200.

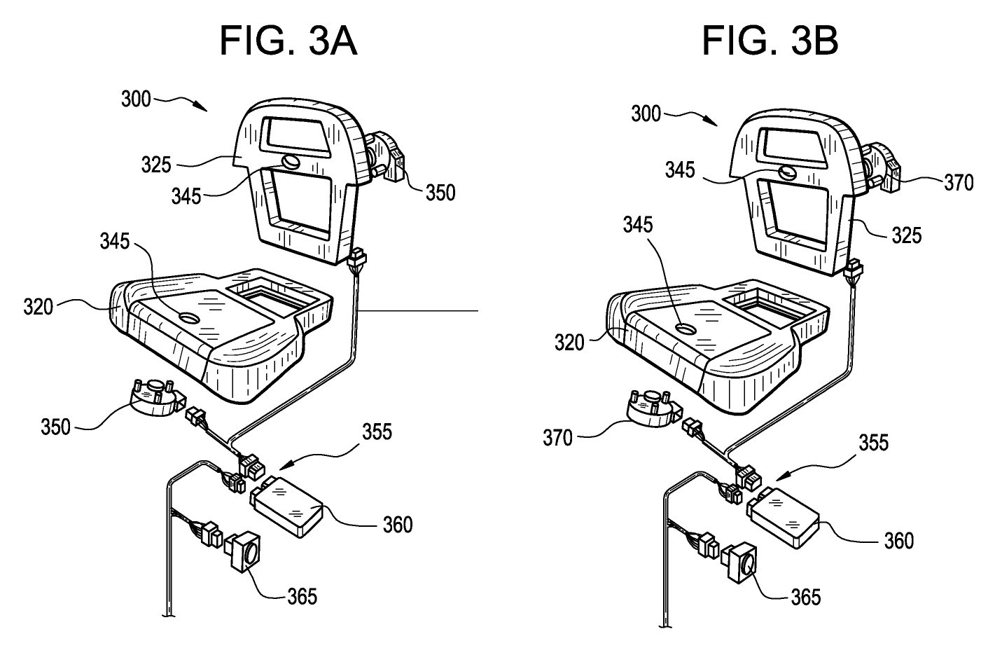

FIGS. 3A and 3B provide a heated seat 300 that uses a thermally regulating heater 305 in the form of fan blades and a comparison to prior art heated seats. In this embodiment, the heated seat 300 includes a seat portion 320 and a back portion 325. These portions include openings 345 through which air may be passed to contact the individual in the seat 300. In the prior art embodiment depicted in FIG. 3A, the heated seat 300 uses thermoelectric devices (TED) 350 that contain Peltier circuits 355 that require signals from the control module 360 to regulate hot and cold signals. The control module 360 regulates voltage to each TED 350 and interprets signals from the switch unit 365. The switch unit 365 signals control module: hot, cold, off.

FIG. 3B provides a heated seat 300 according to an alternative embodiment of the present invention. In this embodiment, the heated seat 300 uses fan units 370 and there is no control module. The fans inside the fan units 370 are made of a polymeric PTC composition. When the switch unit 365 is set to hot, current is sent to the fan that blows self-generated heat. Since the polymeric PTC composition is has lower trip temperatures, no control module is required to ensure that the air does not become too hot, although it is to be understood that a control system may be used if desired. For venting, the fan spins without producing heat. As with the prior art embodiment, the switch unit 365 signals the fan units 370: hot, cold, off.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A heated seat comprising:
a molded polymeric positive temperature coefficient composition; and
at least two electrodes in electrical contact with the heated seat for supplying electric current to the heated seat;
wherein the molded polymeric positive temperature coefficient composition comprises an organic polymer and a conductive filler.

2. The heated seat of claim 1, wherein the polymeric positive temperature coefficient composition comprises:
an organic polymer; and
an electrically conducting filler selected from a ceramic filler, a metal powder, or a combination comprising at least one of the foregoing electrically conducting fillers;
wherein at least one of the ceramic fillers or the metal powders has a hardness of greater than or equal to 500 Vickers;
further wherein the polymeric positive temperature coefficient composition has a trip temperature less than the heat deflection temperature of the polymeric positive temperature coefficient composition at 0.45 MPa and wherein the difference between the trip temperature and the heat deflection temperature is 10° C. or greater.

3. The heated seat of claim 2, wherein the organic polymer comprises an amorphous polymer.

4. The heated seat of claim 2, wherein the organic polymer comprises a semi-crystalline polymer.

5. The heated seat of claim 2, wherein the ceramic filler is electrically conducting and is selected from titanium diboride, tin oxide, indium tin oxide, antimony tin oxide, tungsten carbide, titanium nitride, zirconium nitride, titanium carbide, molybdenum silicide, potassium titanate whiskers, vanadium oxide or a combination comprising at least one of the foregoing ceramic fillers.

6. The heated seat of claim 2, wherein the metal powder is selected from silver, vanadium, tungsten, nickel, stainless steel, neodymium iron boron (NdFeB), samarium cobalt (SmCo), aluminum nickel cobalt (AlNiCo), or a combination comprising at least one of the foregoing metal powders.

7. The heated seat of claim 2, wherein the ceramic filler and/or the metal powder has an average particle size of less than or equal to 1,000 nanometers.

8. The heated seat of claim 2, wherein at least one of the ceramic fillers or the metal powders has a hardness of greater than or equal to 500 Vickers.

9. The heated seat of claim 2, wherein the polymeric positive temperature coefficient composition comprises another electrically conducting filler composition selected from carbon black, carbon nanotubes, graphite, metal coated fillers, or a combination comprising at least one for the foregoing.

10. The heated seat of claim 1, wherein the heated seat further comprises a support substrate comprising a thermoplastic material.

11. The heated seat of claim 10, wherein the thermoplastic material is selected from acrylonitrile-butadiene-styrene (ABS), polycarbonate, polycarbonate/ABS blend, a copolycarbonate-polyester, acrylic-styrene-acrylonitrile (ASA), acrylonitrile-(ethylene-polypropylene diamine modified)-styrene (AES), phenylene ether resins, glass filled blends of polyphenylene oxide and polystyrene, blends of polyphenylene ether/polyamide, blends of polycarbonate/PET/PBT, polybutylene terephthalate and impact modifier, polyamides, phenylene sulfide resins, polyvinyl chloride PVC, high impact polystyrene (HIPS), low/high density polyethylene, polypropylene and thermoplastic olefins (TPO), polyethylene and fiber composites, polypropylene and fiber composites, or a combination thereof.

12. The self-regulating heated article of claim 1, wherein the polymeric positive temperature coefficient composition is in a form of a sheet.

13. The heated seat of claim 1, wherein the polymeric positive temperature coefficient composition is in a form of a fan blade.

14. The heated seat of claim 1, wherein the polymeric positive temperature coefficient composition is in a form of a film.

15. The s heated seat of claim 1, wherein the polymeric positive temperature coefficient composition is in a form of a foam.

16. The heated seat of claim 1, wherein at least one electrode comprises a path of conductive silver ink.

17. A method of forming a heated seat comprising the steps of:
forming a molded heated seat comprising a polymeric positive temperature coefficient composition; and
integrating at least two electrodes in electrical contact with the heated seat for supplying electric current to the heated seat.

18. The method of claim 17, wherein the heated seat is molded using a molding process selected from extrusion molding, blow molding, a compression molding, injection molding, compression-injection molding, melt molding (such as co-extrusion molding), T-die extrusion, inflation extrusion, profile extrusion, extrusion coating and multi-layer injection molding or a combination including one of the foregoing methods.

19. The method of claim 18, wherein the heated seat is molded using an injection molding process.
